(19) United States
(12) Patent Application Publication
(10) Pub. No.: US 2013/0218956 A1
(43) Pub. Date: Aug. 22, 2013

(54) METHOD AND CLIENT FOR OFFLINE OPERATION

(71) Applicant: TENCENT TECHNOLOGY (SHENZHEN) COMPANY LIMITED, (US)

(72) Inventor: Zhihao Zheng, Guangdong (CN)

(73) Assignee: TENCENT TECHNOLOGY (SHENZHEN) COMPANY LIMITED, Guangdong (CN)

(21) Appl. No.: 13/849,917

(22) Filed: Mar. 25, 2013

Related U.S. Application Data
(63) Continuation of application No. PCT/CN2011/079224, filed on Sep. 1, 2011.

(30) Foreign Application Priority Data
Oct. 26, 2010 (CN) 201010522258.X

(51) Int. Cl. H04L 29/06

(52) U.S. Cl. CPC H04L 67/42
USPC 709/203

(57) ABSTRACT

A method of offline operation for a client, comprises the steps of obtaining and displaying a user interface; and determining whether the client is connected to a network, and if so, synchronizing offline operation data previously stored by the client to a server, otherwise conducting offline operation, wherein the offline operation comprises the steps of obtaining in real time and storing user offline operation data; and refreshing and displaying the User interface, based on the user offline operation data obtained in real time and stored. A client for offline operation, which stores user offline operation data upon being disconnected from the network so that user offline operation data will not be lost and will be reflected upon the user interface being refreshed or switched to, and synchronizes user operation data to a server upon being connected to the network to ensure consistent user experiences.

### CROSS-REFERENCE TO RELATED APPLICATIONS

This application is a continuation of International Patent Application No. PCT/CN2011/079224, filed on Sep. 1, 2011. This application claims the benefit and priority of Chinese Patent Application No. 201010522258.X, filed on Oct. 26, 2010. The entire disclosures of each of the above applications are incorporated herein by reference.

### TECHNOLOGICAL FIELD

The present invention relates to Internet technologies, particularly those involving methods and clients for offline operation.

### BACKGROUND OF THE INVENTION

In the prior art, application programs at the client side often need to exchange data with a server; if a user wants to use a functionality of the client that needs to exchange data with a server, he would have to wait until the client is connected to a network. In the following discussion, the term client may refer to a client terminal device, or a client side application program.

This is especially inconvenient for mobile devices, such as mobile handsets, which may enter areas with poor network connection that prevent the user from using functionalities that need to exchange data with a server, and the user will have to wait until the client is connected to a network. Thus, user operation is often interrupted, which affects the quality of the user's experience, wastes the user's time, and may result in the loss of user data.

### SUMMARY OF THE INVENTION

Thus, it is desirable to provide a method of offline operation for a client that allows users to continue to use the client while offline.

It is provided a method of offline client, which comprises the steps of obtaining and displaying a user interface; and determining whether the client is connected to a network, and if so, synchronizing offline operation data previously stored by the client to a server, otherwise conducting offline operation, wherein the offline operation comprises the steps of obtaining in real time and storing user offline operation data; and refreshing and displaying the user interface based on the user offline operation data obtained in real time and stored.

Preferably, the step of obtaining and displaying a user interface is based on offline operation data previously stored by the client.

Preferably, the method further comprises determining whether offline operation data obtained in real time has been stored before the client shuts down, and if not, storing offline operation data obtained in real time before the client shuts down.

Preferably, the method further comprises, after determining whether the client is connected to a network, determining whether an offline operation mode has been initiated and if so, synchronizing user operation data previously stored by the client to a server or conducting offline operation, otherwise determining whether the client is connected to a network.

Preferably, the method further comprises displaying an activated network synchronization signal in the user interface after determining the client is connected to the network, and displaying an un-activated network synchronization signal in the user interface after determining the client is not connected to the network.

It is also provided a method of offline operation for a client, which comprises the steps of obtaining and displaying a user interface; obtaining user operation data; determining whether the client is connected to a network, and if not, storing user operation data as offline operation data, otherwise synchronizing the user operation data to a server.

Preferably, the method further comprises determining, after obtaining user operation data, whether a network is required to complete an operation on the user operation data, and if so, determining whether the client is connected to a network, otherwise conducting the operation on the user operation data, and afterwards obtaining and displaying a user interface based on the result of the operation.

Preferably, the method further comprises, after determining the client is connected to a network, completing an operation through the network; and determining whether an offline operation mode has been initiated and if so, synchronizing the offline operation data to a server.

Preferably, the method further comprises, after determining the client is not connected to a network, determining whether an offline operation mode has been initiated and if so, storing user operation data as offline operation data, and afterwards obtaining and displaying a user interface based on the offline operation data; otherwise, ending operation.

Preferably, the method further comprises determining whether the offline operation data has been stored before the client shuts down, and if not, store offline operation data before the client shuts down.

It is also desirable to provide a client for offline operation that allows users to continue to use the client while offline.

It is provided a client for offline operation, which comprises a user interface display module; a network monitoring module; an offline operation data cache module; a data synchronization module; and an offline operation acquisition module; wherein the offline operation data cache module, the user interface display module, the data synchronization module, and the offline operation acquisition module are inter-connected; the network monitoring module is connected to the data synchronization module; the user interface display module is configured to obtain data from the offline operation data cache module and display a user interface; the network monitoring module is configured to determine whether the client is connected to a network; the data synchronization module is configured to synchronize user operation data previously stored by the client to a server when the network monitoring module determines the client is connected to a network; the offline operation acquisition module is configured to obtain user offline operation data in real time and store the obtained user offline operation data to the offline operation data cache module when the network monitoring module determines the client is disconnected to a network; and the offline operation data cache module is configured to store user offline operation data.

Preferably, the client further comprises an accidental shutdown protection module, wherein the accidental shutdown protection module is connected to the offline operation data cache module, and configured to determine whether offline operation data obtained in real time has been stored before the client shuts down, and if not, store offline operation data obtained in real time before the client shuts down.

Preferably, the client further comprises an offline operation mode initiation module, wherein the offline operation mode initiation module is connected to the data synchronization module and the offline operation acquisition module, and configured to determine whether an offline operation mode has been initiated, and if so, initiate the data synchronization mode to synchronize user operation data previously stored by the client to a server, or the offline operation acquisition module to obtain user offline operation data in real time and store the obtained user offline operation data to the offline operation data cache module.

Preferably, the client further comprises a network synchronization signal display module, the network synchronization signal display module is connected to the network monitoring module and the user interface display module, and is configured to display an activated network synchronization signal when the client is determined to be connected to the network, and an un-activated network synchronization signal when the client is determined to be disconnected to the network.

According to methods and clients for offline operation in accordance with embodiments of the present invention, user offline operation data will be stored upon the client being disconnected from the network (offline), and the user interface will be refreshed based on the user offline operation data. Thus, user operation data obtained offline, instead of being lost, will be reflected on the user interface upon being refreshed or switched to, and be synchronized to a server upon being connected to a network to ensure consistent user experiences. It also avoids annualizing user operations and wasting user's time due to the interruption of network connection, and enhances efficiency.

### BRIEF DESCRIPTION OF THE DRAWINGS

FIG. 1 is an exemplary flowchart for a method of offline operation for a client in accordance with an embodiment of the present disclosure.

FIG. 2 is an exemplary flowchart for a method of offline operation for a client in accordance with another embodiment of the present disclosure.

FIG. 3 is an exemplary flowchart for a method of offline operation for a client in accordance with yet another embodiment of the present disclosure.

FIG. 4 is an exemplary flowchart for a method of offline operation for a client in accordance with yet another embodiment of the present disclosure.

FIG. 5 is an exemplary flowchart for a method of offline operation for a client in accordance with yet another embodiment of the present disclosure.

FIG. 6 is an exemplary schematic diagram for a client for offline operation in accordance with an embodiment of the present disclosure.

FIG. 7 is an exemplary schematic diagram for a client for offline operation in accordance with another embodiment of the present disclosure.

### DETAILED DESCRIPTION

To better illustrate the objective, characteristics, and advantages of the present invention, various embodiments of the present invention will be described in detail in conjunction with the accompanying drawings.

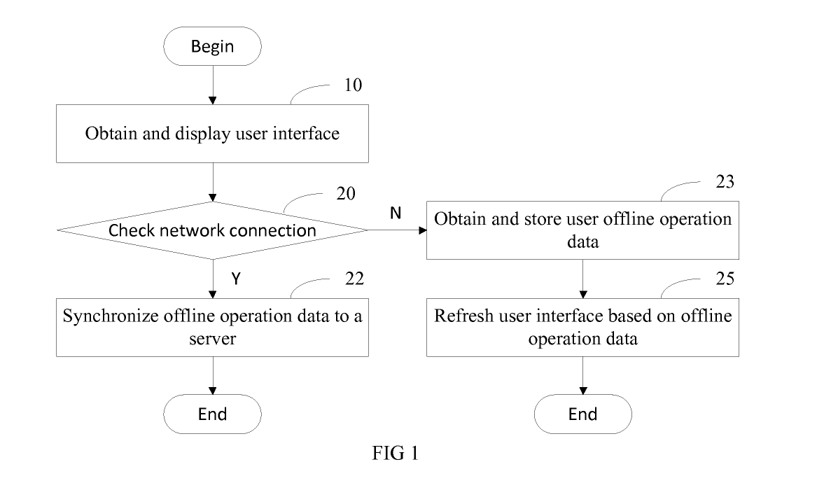

FIG. 1 is an exemplary flowchart for a method of offline operation for a client in accordance with an embodiment. As shown in FIG. 1, the method comprises the following steps.

In step 10, obtain and display the user interface. After the user starts up and logs into the client, obtain the data needed to generate a user interface, and display the user interface.

In step 20, determine whether the client is connected to a network. If the client is connected to a network, then proceed to step 22, otherwise conduct offline operation and proceed to step 23.

In step 22, synchronize offline operation data. Offline operation data stored on the client prior to this synchronization is synchronized to a server.

In step 23, obtain and store user offline operation data. User offline operation data is obtained in real time and stored, which may include texts, pictures, audio and video data.

In step 25, refresh and display the user interface based on the user offline operation data obtained in real time and stored.

In this embodiment, the user interface in step 10 is generated using user offline operation data stored on the client prior to the synchronization in step 22.

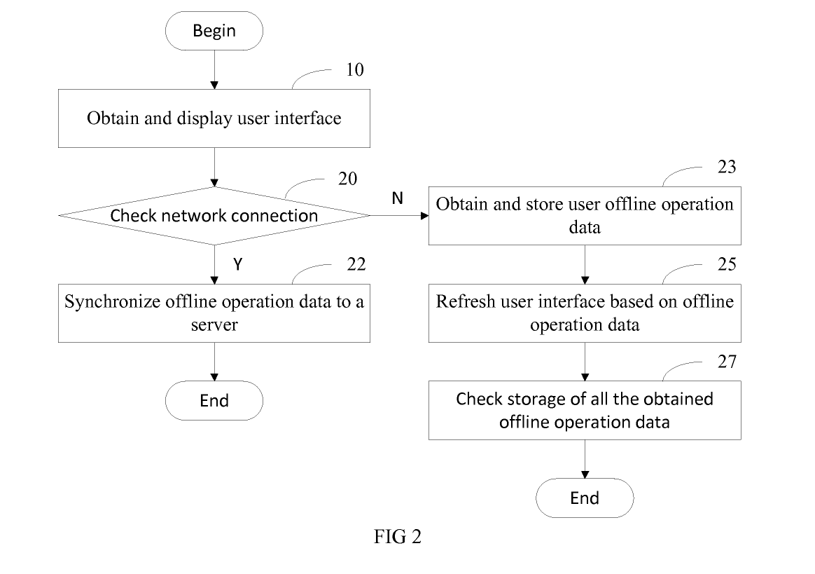

FIG. 2 is an exemplary flowchart for a method of offline operation for a client in accordance with another embodiment. As compared to the method in FIG. 1, this method in FIG. 2 further comprises the following steps:

In step 27, determine whether the obtained offline operation data has been completely stored. Before the client is shut down, determine whether offline operation data obtained in real time has been completely stored, and if not, complete the storing of offline operation data obtained in real time before shutting down the client. This step prevents the loss of data due to the accidental shutdown of the client and other reasons, and enhances efficiency and data security.

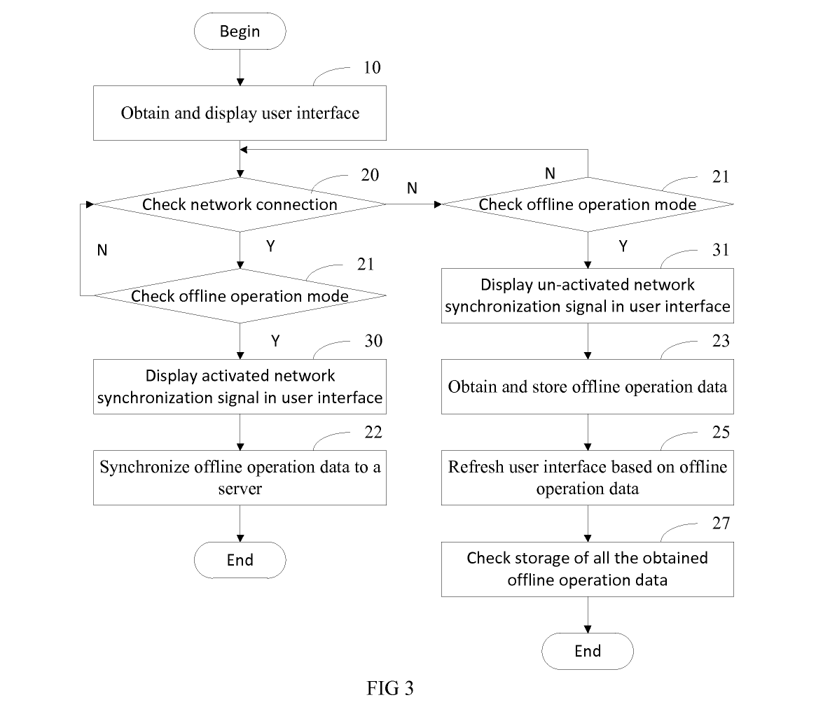

FIG. 3 is an exemplary flowchart for a method of offline operation for a client in accordance with yet another embodiment. As compared to the method in FIG. 2, the method in FIG. 3 further comprises the following steps.

In step 21, determine whether an offline operation mode has been initiated. In this embodiment, step 21 is performed after step 20. If the offline operation mode is on, then proceed to step 30 or step 31, otherwise, return to step 20. Whether proceeding to step 30 or S31 depends on the result in step 20.

In step 30, display an activated network synchronization signal in the user interface. After determining the client is connected to the network, display an activated network synchronization signal in the user interface to alert the user of the synchronization to be performed in step 22. In a preferred embodiment, step 30 further includes prompting the user that the client is connected to the network. This feature enhances user experience, as it makes it easy for the user to understand how to use the client.

In step 31, display an un-activated network synchronization signal in the user interface. After determining the client is not connected to the network, display an un-activated network synchronization signal in the user interface. Step 31 corresponds to step 30, and indicates that the client is not in the process of synchronizing offline operation data to a server.

In this embodiment, user offline operations can be divided into two types: one is inputting data, such as text input, or the insertion of picture, audio, and video data; the other is switching or refreshing the user interface, which will generate an operation instruction. For the first type of user offline operation, in step 23, obtain input data, store it in the client's offline operation data cache module, and display a corresponding message at the same time; in step 25, display the inputted data in the user interface so that the user will have the same experience as if the client is connected to a network. For the second type of user offline operation, in step 23, obtain the operation instruction; in step 25, display the offline operation data stored in the offline operation data cache module in the corresponding location of the refreshed or switched-to user interface in accordance with the operation instruction.

In this embodiment, in step 22, after the offline operation data is synchronized to the server, delete the offline operation data stored in the offline operation data cache module to save the storage space on the client. The deletion can be performed at the same time as the synchronization, such as deleting a portion of the data, such as a record, right after that portion of the data has been successfully synchronized. The deletion can also be performed after all the data has been successfully synchronized.

In this embodiment, after all the data has been synchronized, display an un-activated network synchronization signal in the user interface, indicating that the client is not in the process of synchronizing offline operation data to a server. In a preferred embodiment, while synchronizing data to the server, obtain from the server the most-recent data, and display that in the user interface.

The method of offline operation is mostly applicable to mobile handsets, as mobile handsets are consistently on the move, and the network environment is subject to constant change. To further illustrate the process of the offline operation method, it will be discussed below in connection with a client on a personal mobile phone.

In step 10, obtain and display the user interface. If the client is not connected to a network, then it is necessary to obtain data needed to generating a user interface from an offline operation data cache module. The data was offline operation data previously stored by the client.

In step 20, determine whether the client is connected to a network. For mobile handsets, the network environment is subject to change at any time, so in practice the network status may be checked at certain intervals.

In step 21, determine whether an offline operation mode has been initiated. If the offline operation mode is on, then proceed to step 30 or step 31, otherwise, return to step 20. Whether proceeding to step 30 or S31 depends on the result in step 20.

In step 30, display an activated network synchronization signal in the user interface. After determining the client is connected to the network, display an activated network synchronization signal in the user interface to alert the user of the synchronization to be performed in step 22. At the same time, display a prompt indicating to the user that the client is connected to the network.

In step 22, synchronize offline operation data. Offline operation data stored on the client prior to this synchronization is synchronized to a server. The offline operation data was temporarily stored in the offline operation data cache module while the client is disconnected from the network.

After the offline operation data is synchronized the server, delete the offline operation data stored in the offline operation data cache module to save the storage space on the client. The deletion can be performed at the same time as the synchronization, such as deleting a portion of the data, such as a record, right after that portion of the data has been successfully synchronized. The deletion can also be performed after all the data has been successfully synchronized.

After all the data has been synchronized, display an un-activated network synchronization signal in the user interface, indicating that the client is not in the process of synchronizing offline operation data to a server. Also, while synchronizing data to the server, obtain from the server the most-recent data and display that in the user interface, such as retrieving a message from a friend.

In step 31, display an un-activated network synchronization signal in the user interface. After determining the client is not connected to the network, display an un-activated network synchronization signal in the user interface. This step corresponds to step 30, indicating that the client is not in the process of synchronizing offline operation data to a server.

In step 23, obtain and store user offline operation data. User offline operation data is obtained in real time and stored.

In step 25, refresh and display the user interface based on the user offline operation data obtained in real time and stored.

User offline operations can be divided into two types: one is inputting data, such as inputting inputted into a diary, inserting pictures into an album, or uploading an audio file to a music box; the other is switching or refreshing the user interface, such as switching from a main page to an album page, which will generate a switching instruction.

For the first type of user offline operation, in step 23, obtain input data, such as text input into a diary, and stored it in the client's offline operation data cache module, and display a corresponding message; in step 25, display the input text in the user interface for the diary, such as displaying the updated text in the diary, so that the user will have the same experience as if the client is connected to a network.

For the second type of user offline operation, in step 23, obtain the operation instruction; in step 25, display the offline operation data stored in the offline operation data cache module in the corresponding location of the refreshed or switched-to user interface in accordance with the operation instruction. For example, when the user interface is switched from the album to the diary, a switching instruction will be generated, and in step 25, reading the offline operation data (such as text in a diary) stored in the offline operation data cache module in the user interface for the diary in accordance with the operation instruction, and displaying the offline operation data (such as the updated diary).

In step 27, determine whether the obtained offline operation data has been completely stored. Before the client is shut down, determine whether offline operation data obtained in real time has been completely stored, and if not, complete the storing of offline operation data obtained in real time before shutting down the client. This step prevents the loss of data due to the accidental shutdown of the client and other reasons, and enhances efficiency and data security.

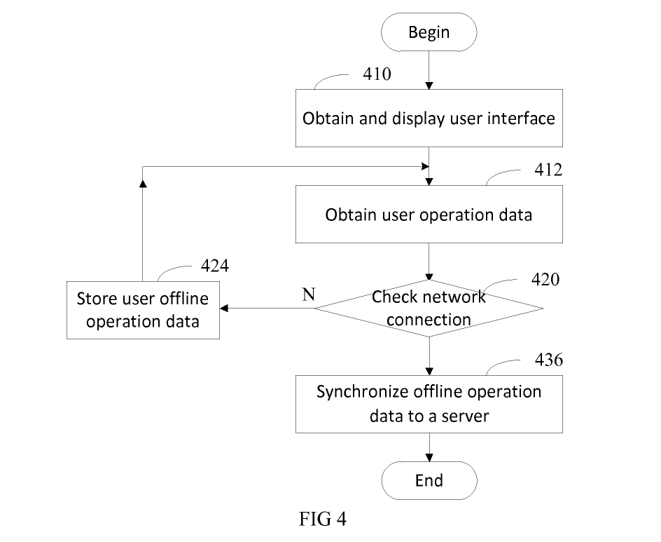

FIG. 4 is an exemplary flowchart for a method of offline operation for a client in accordance with yet another embodiment. As shown in FIG. 4, the method comprises the following steps:

In step 410, obtain and display the user interface.

In step 412, obtain user operation data.

In step 420, determine whether the client is connected to a network. If the client is connected to a network, then proceed to step 424, otherwise proceed to step 436.

In step 424, store user operation data as offline operation data.

In step 436, synchronize the offline operation data to a server.

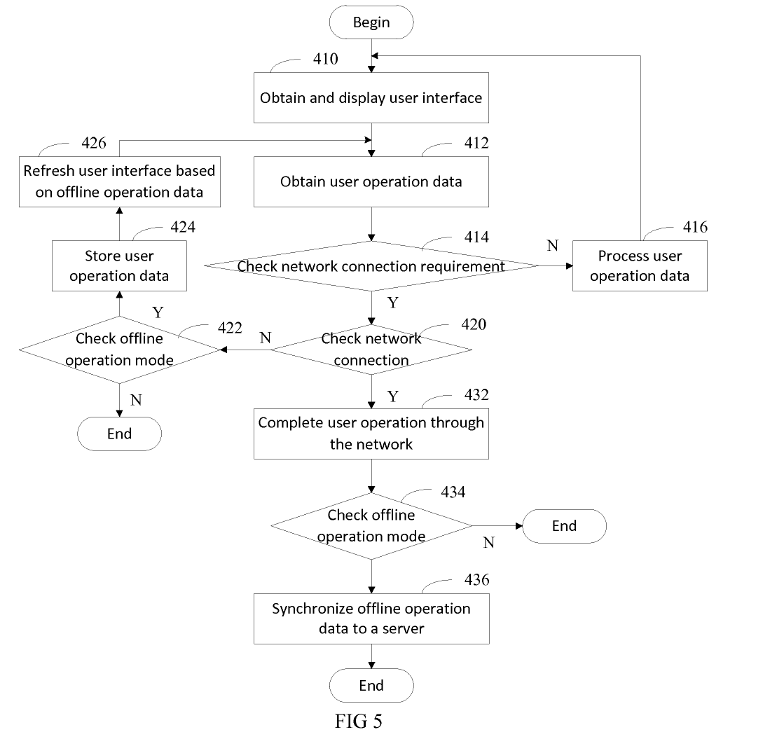

FIG. 5 is an exemplary flowchart for a method of offline operation for a client in accordance with yet another embodiment, and provides further concrete implementation details for the embodiment in FIG. 4. As shown in FIG. 5, the method comprises the following steps:

In step 410, obtain and display the user interface. After the user starts up and log into the client, obtain the data needed to generating a user interface, and display the user interface.

In step 412, obtain user operation data. The use operation data is generated by the user operation.

In step 414, determine whether the user operation requires the client being connected to a network. If the user operation requires the client being connected to a network, then proceed to step 420, otherwise proceed to step 416.

In step 416, process user operation data, and returns to step 410. At this time, in step 410, the user interface obtained and displayed is based on the result obtained in step 416.

In step 420, determine whether the client is connected to a network. If the client is not connected to a network, then proceed to step 422, otherwise proceed to step 432.

In step 422 determine whether an offline operation mode has been initiated. If the offline operation mode is on, then proceed to step 424; otherwise end, and the client may prompt using the user that the network connection is not available. The prompt may be generated by techniques that are generally known in the art.

In step 424, store user offline operation data. User operation data is stored as offline operation data, which may include texts, pictures, audio and video data.

In step 426, refresh and display the user interface based on the user offline operation data, and proceed to step 412.

In step 432, complete user operation through the network. Send user operation data to the server, let the server process the user operation and send relevant processing information back to the client.

In step 434, determine whether the offline operation mode has been initiated. If so, proceed to step 436, otherwise end.

In step 436, synchronize the offline operation data to a server.

In a preferred embodiment, after determining the client is connected to the network, and the offline operation mode has been initiated, display an activated network synchronization signal in the user interface to alert the user of the synchronization to be performed in step 434. After all offline operation data has been synchronized to the server, change the network synchronization signal to an un-activated status. Similarly, after determining the client is not connected to the network, display an un-activated network synchronization signal in the user interface.

During the operation of the client, the user may shut down the client at any time. In a preferred embodiment, in a preferred embodiment, in step 424, before the client is shut down, determine whether offline operation data obtained in real time has been completely stored, and if not, complete the storing of offline operation data obtained in real time before shutting down the client. This step prevents the loss of data due to the accidental shutdown of the client and other reasons, and enhances efficiency and data security.

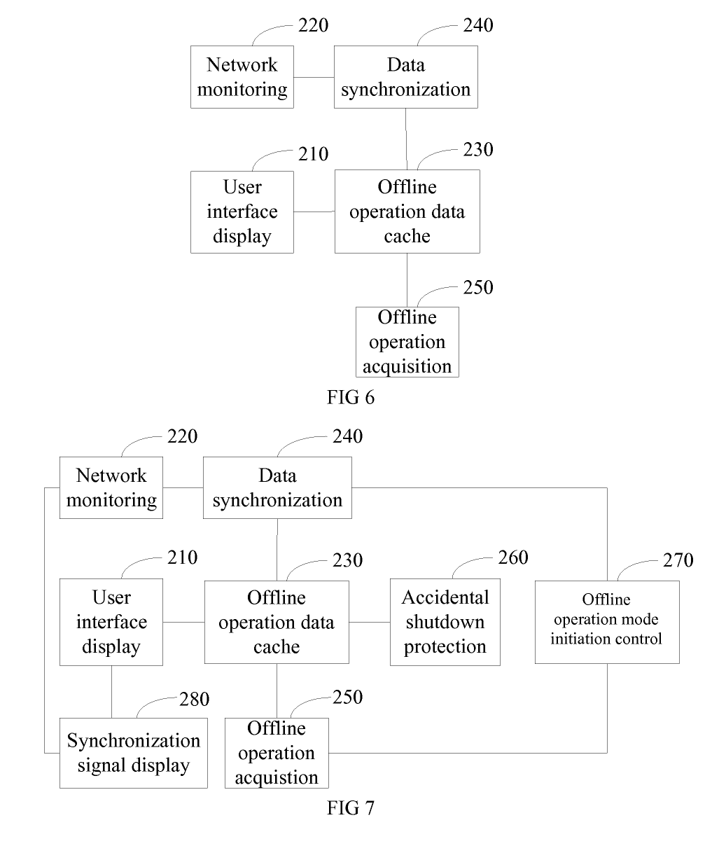

In accordance with embodiments of the present invention, a client for offline operation is also provided. FIG. 6 is an exemplary schematic diagram for a client for offline operation in accordance with one embodiment. As shown in FIG. 6, the client includes a user interface display module 210, a network monitoring module 220, an offline operation data cache module 230, a data synchronization module 240, and an offline operation acquisition module 250. The offline operation data cache module 230, the user interface display module 210, the data synchronization module 240, and the offline operation acquisition module 250 are all inter-connected; the network monitoring module 220 is connected to the data synchronization module 240.

The user interface display module 210 is used to obtain data from the offline operation data cache module 230 and display a user interface. After a user starts up and logs into a client, the user interface display module 210 obtains data needed for generating a user interface from the server or the offline operation data cache module 230, and display a user interface.

The network monitoring module 220 is used to monitor network connection. For mobile devices, the network environment is subject to change at any time, so in practice the network status is often checked at certain intervals.

The offline operation data cache module 230 is used to store user offline operation data. When the client is not connected to the network, the user's offline operation data will be temporarily stored in the offline operation data cache module 230.

The data synchronization module 240 is used, when the network monitoring module 220 determines that the client is connected to the network, to synchronize offline operation data previously stored in the offline operation data cache module 230 to the server.

The offline operation acquisition module 250 is used, when the network monitoring module 240 determines that the client is disconnected from the network, to access the user's offline operation data in real time and store it to the operating data cache module 230.

FIG. 7 is an exemplary schematic diagram for a client for offline operation in accordance with another embodiment. As compared to the client in FIG. 6, the client in FIG. 7 further includes an accidental shutdown protection module 260, an offline operation mode initiation control module 270, and a network synchronization signal display module 280.

The accidental shutdown protection module 260 is connected to the offline operation data cache module 230, and is used to determine whether all the offline operation data obtained in real time has been stored (i.e., whether all the data has been stored in the offline operation data cache module 230) before shutting down the client, and if not, store offline operation data obtained in real time before shutting down the client.

The offline operation mode initiation control module 270 is connected to the data synchronization module 240 and the offline operation acquisition module 250, is used to determine whether an offline operation mode has been initiated. If the offline operation mode has been initiated, and the client is connected to the network, then the data synchronization mode 240 synchronizes user operation data previously stored in the offline operation data cache module 230 to a server; if the client is not connected to the network, then offline operation acquisition module 250 obtain user offline operation data in real time and stores the obtained user offline operation data to the offline operation data cache module 230.

The network synchronization signal display module 280 is connected to the network monitoring module 220 and the user interface display module 210, and is used to display an activated network synchronization signal when the client is determined to be connected to the network, and an un-activated network synchronization signal when the client is determined to be disconnected to the network.

According to the methods and clients for offline operation in accordance with embodiments of the present invention, user offline operation data will be stored upon the client being disconnected from the network (offline), and the user interface will be refreshed based on the user offline operation data. Thus, user operation data obtained offline will, be reflected on the user interface upon being refreshed or switched to instead of being lost, and be synchronized to a server upon being connected to a network to ensure consistent user experiences.

The above detailed descriptions are but for several specific embodiments of the present invention, and are not intended to limit the scope of the present invention. Any modification or improvement made by person of ordinary skill in the art without deviating from the principles of the present invention is still within the scope of the present invention, which is defined solely by the appended claims.

What is claimed is:

1. A method of offline operation for a client, comprises the steps of:
obtaining and displaying a user interface; and
determining whether the client is connected to a network, and if so, synchronizing offline operation data previously stored by the client to a server, otherwise conducting offline operation, wherein the offline operation comprises the steps of
obtaining in real time and storing user offline operation data; and
refreshing and displaying the user interface based on the user offline operation data obtained in real time and stored.

2. The method of claim 1, wherein the step of obtaining and displaying a user interface is based on offline operation data previously stored by the client.

3. The method of claim 1, further comprises determining whether offline operation data obtained in real time has been stored before the client shuts down, and if not, storing offline operation data obtained in real time before the client shuts down.

4. The method of claim 1, further comprises, after determining whether the client is connected to a network, determining whether an offline operation mode has been initiated and if so, synchronizing user operation data previously stored by the client to a server or conducting offline operation, otherwise determining whether the client is connected to a network.

5. The method of claim 1, further comprises displaying an activated network synchronization signal in the user interface after determining the client is connected to the network, and displaying an un-activated network synchronization signal in the user interface after determining the client is not connected to the network.

6. A method of offline operation for a client, comprises the steps of:
obtaining and displaying a user interface;
obtaining user operation data;
determining whether the client is connected to a network, and if not, storing user operation data as offline operation data, otherwise synchronizing the user operation data to a server.

7. The method of claim 6, further comprises determining, after obtaining user operation data, whether a network is required to complete an operation on the user operation data, and if so, determining whether the client is connected to a network, otherwise conducting the operation on the user operation data, and afterwards obtaining and displaying a user interface based on the result of the operation.

8. The method of claim 6, further comprises, after determining the client is connected to a network, completing an operation through the network; and determining whether an offline operation mode has been initiated and if so, synchronizing the offline operation data to a server.

9. The method of claim 6, further comprises, after determining the client is not connected to a network, determining whether an offline operation mode has been initiated and if so, storing user operation data as offline operation data, and afterwards obtaining and displaying a user interface based on the offline operation data.

10. The method of claim 6, further comprises determining whether the offline operation data has been stored before the client shuts down, and if not, store offline operation data before the client shuts down.

11. A client for offline operation, comprises
a user interface display module;
a network monitoring module;
an offline operation data cache module;
a data synchronization module; and
an offline operation acquisition module; wherein
the offline operation data cache module, the user interface display module, the data synchronization module, and the offline operation acquisition module are inter-connected;
the network monitoring module is connected to the data synchronization module;
the user interface display module is configured to obtain data from the offline operation data cache module and display a user interface;
the network monitoring module is configured to determine whether the client is connected to a network;
the data synchronization module is configured to synchronize user operation data previously stored by the client to a server when the network monitoring module determines the client is connected to a network;
the offline operation acquisition module is configured to obtain user offline operation data in real time and store the obtained user offline operation data to the offline operation data cache module when the network monitoring module determines the client is disconnected to a network; and
the offline operation data cache module is configured to store user offline operation data.

12. The client of claim 11, further comprises an accidental shutdown protection module, wherein the accidental shutdown protection module is connected to the offline operation data cache module, and configured to determine whether offline operation data obtained in real time has been stored before the client shuts down, and if not, store offline operation data obtained in real time before the client shuts down.

13. The client of claim 11, further comprises an offline operation mode initiation control module, wherein the offline operation mode initiation control module is connected to the data synchronization module and the offline operation acquisition module, and configured to determine whether an offline operation mode has been initiated, and if so, initiate the data synchronization mode to synchronize user operation data previously stored by the client to a server, or the offline operation acquisition module to obtain user offline operation data in real time and store the obtained user offline operation data to the offline operation data cache module.

14. The client of claim 11, further comprises a network synchronization signal display module, the network synchronization signal display module is connected to the network monitoring module and the user interface display module, and is configured to display an activated network synchronization signal when the client is determined to be connected to the network, and an un-activated network synchronization signal when the client is determined to be disconnected to the network.
